(19) United States
(12) Patent Application Publication
(10) Pub. No.: US 2025/0054655 A1
(43) Pub. Date: Feb. 13, 2025

(54) DATA CABLE WITH AN ANTI-STRETCHING AND BITE-RESISTANT WOVEN LAYER

(71) Applicant: CHING MAN WONG, HONG KONG (CN)

(72) Inventor: CHING MAN WONG, HONG KONG (CN)

(21) Appl. No.: 18/234,584

(22) Filed: Aug. 16, 2023

(30) Foreign Application Priority Data
Aug. 7, 2023 (CN) 202322105241.X

(51) Int. Cl. H01B 7/18

(52) U.S. Cl. CPC H01B 7/1805

(57) ABSTRACT

The present disclosure discloses a data cable with an anti-stretching and bite-resistant woven layer, which includes multiple inner core wires, an isolation layer wrapping the inner core wires, a metal protective layer provided on an outer surface of the isolation layer and wrapping the isolation layer; the metal protective layer is composed of multiple strands of metallic thread that that are woven by overlapping in a transverse direction and diagonal direction to form a dense network structure, rendering the metal protective layer have bite-resistant and anti-stretching properties; the metallic thread is made of a metal wire having high tensile strength or mixed with nylon wire and carbon fiber wire to weave into strands, allowing the data cable to be bending at a certain degree of curvature and avoiding knots. A surface of the metal wire has an insulation layer.

### CROSS-REFERENCE TO RELATED APPLICATIONS

This is a U. S. patent application which claims the priority and benefit of Chinese Patent Application Number 202322105241. X, filed on Aug. 7, 2023, the disclosure of which is incorporated herein by reference in its entirety.

### TECHNICAL FIELD

The present disclosure relates to the field of data cable technologies, and in particular, to a data cable with an anti-stretching and bite-resistant woven layer.

### BACKGROUND

With a popularization of electronics applications, the demand for data cables used for the electronics is growing rapidly. With an increasing number of home pets, the population of pet owners is no longer satisfied with a common data cable due to a powerful destructive of the home pets on household items. In an existing technology, a data cable applying a metal spring tube, the data cable is wrapped by a metal sheet that is winding into a shape of a spring tube, which achieves a goal of not being easily damaged by pets. However, the external metal sheet is a conductive material, it is easy to generate a fire caused by a short circuit between metal pins of a power adapter and a metal spring tube. It has attempted to adding an insulation coating on the metal spring tube to solve the short circuit problem, while, the insulation coating can be only added on the a surface of the tube wall of the metal spring tube and cannot be added on an inner side of the metal spring tube, and the insulation coating may be damaged due to repeated friction or pet bites, and a bare metal tube wall will be exposed, or a gap will be generated as a stretching of the spring tube caused by frequent pulling under an external force and results in an exterior side of the metal spring tube without coating being exposed. Thus, once the outer wall and the inter metal surface come into contact with the pins of the power adapter, a short circuit will be formed and causes a fire. This type of data cable has multiple cases of electrical damages due to short circuits and fires due to local high temperatures after short circuits when used with a charging device. A resilience of this kind of metal spring tube data cable decreases after frequent pulling, and results in a larger gap generated, the inner core line exposed, losing the protection for the inner core line, and shortening a service life of the data cable.

### SUMMARY

A main objective of the present disclosure is to provide a data cable with an anti-stretching and bite-resistant woven layer, aiming to solve defects of an existing data cable with poor overall strength, poor bite-resistant, poor stretching, and poor bending, short service life, poor durability of an insulation effect of a common metal spring tube, and a risk of a short circuit when the metal spring tube is used with a charging device.

To achieve the above objectives, the present disclosure provides a data cable with an anti-stretching and bite-resistant woven layer, which includes an inner core wire, where the inner core wire includes several sub wires, the sub wires include two power lines and two signal lines; an isolation layer wrapping the inner core wire and serving an isolation protection; a single metallic thread that is woven into an anti-stretching and bite-resistant metal protective layer by crossing and overlapping.

In an embodiment, the isolation layer is made of a flexible tube of a plastic or a silicone material.

In an embodiment, the metal protective layer is composed of multiple strands of metallic thread that are woven by overlapping in a transverse direction and diagonal direction to form a dense network structure; the transverse direction is a direction parallel to a core axis of the data cable, and the diagonal direction is a direction that is inclined at a certain angle with a parallel line of the core axis of the data cable.

In an embodiment, the metallic thread is made of a metal wire having high tensile strength, or is made of the metal wire with nylon wire and carbon fiber wire to weave into strands.

In an embodiment, a surface of the metal wire has an insulation layer, which provides an insulation protection for the surface of the metal woven layer.

In the technical solution provided by the present disclosure, a unique weaving process is used to form a metal woven protective layer by mixing metal wire or materials such as nylon wire or carbon fiber wire, thereby improving the anti-stretching and bite-resistant strength of the data cable. When the data cable is subjected by an external force, such as pet bites, the metal protective layer plays a role of protecting the inner core line, rendering the inner core line less prone to damage. The woven data cable has good bite-resistant, anti-stretching, and anti-bending properties, and which greatly increases its service life, and reduces a risk of a short circuit caused by a surface conductivity of the metal data cable when used with the insulation layer.

### BRIEF DESCRIPTION OF DRAWINGS

One or more embodiments are illustrated with corresponding drawings, which do not constitute a limitation of the embodiments. Elements with the same reference numerals in the drawings represent similar elements, unless otherwise stated, and the figures in the drawings do not constitute a limitation of proportion.

FIG. 1 is a structural schematic diagram of a data cable of an embodiment of the present disclosure.

FIG. 2 is a schematic diagram of a woven form of the data cable of an embodiment of the present disclosure.

FIG. 3 is a A-A section diagram of FIG. 1.

FIG. 4 is a partially enlarged view in B of FIG. 3.

Number reference: 1. Inner core wire; 2. Isolation layer; 3. Single stranded metallic thread; 4. Metal wire.

### DETAILED DESCRIPTION

The following will provide a clear and complete description of the technical solution in the embodiment of the present disclosure in combination with the drawings. Obviously, the described embodiments are only a part of the embodiments of the present disclosure, not all of them.

The examples of the embodiments are shown in the drawings, the same or similar number reference throughout indicate the same or similar elements or components with the same or similar functions. The embodiments described below with reference to the drawings are exemplary and intended to explain the present disclosure, but cannot be understood as limitations to the present disclosure.

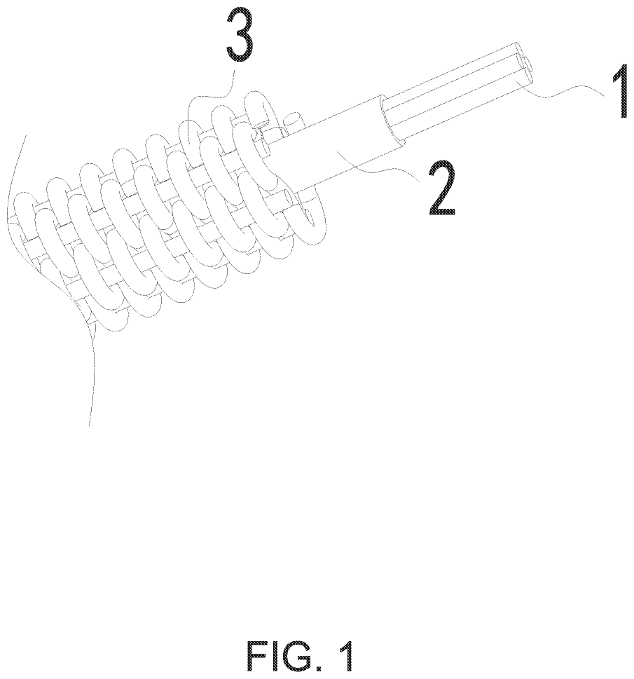

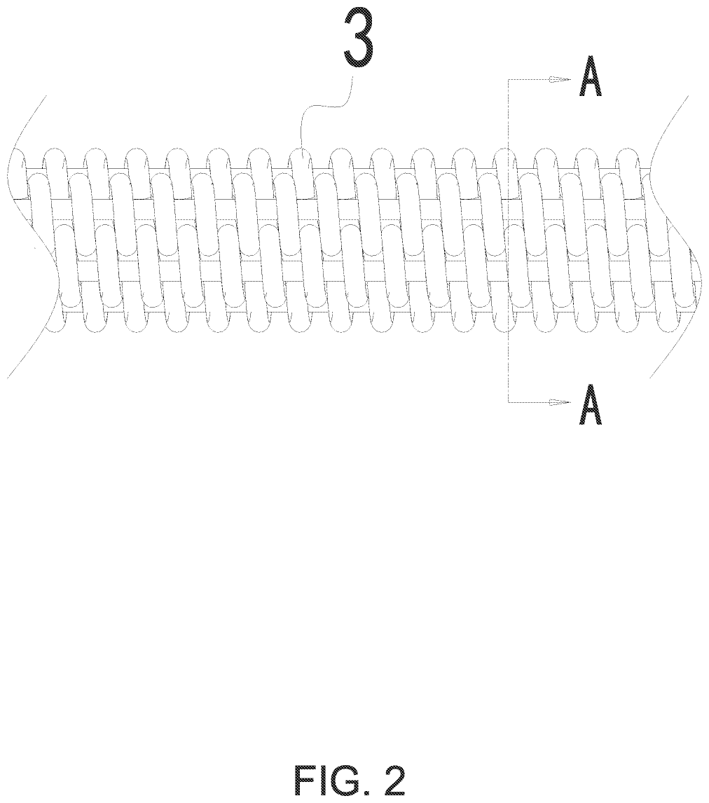

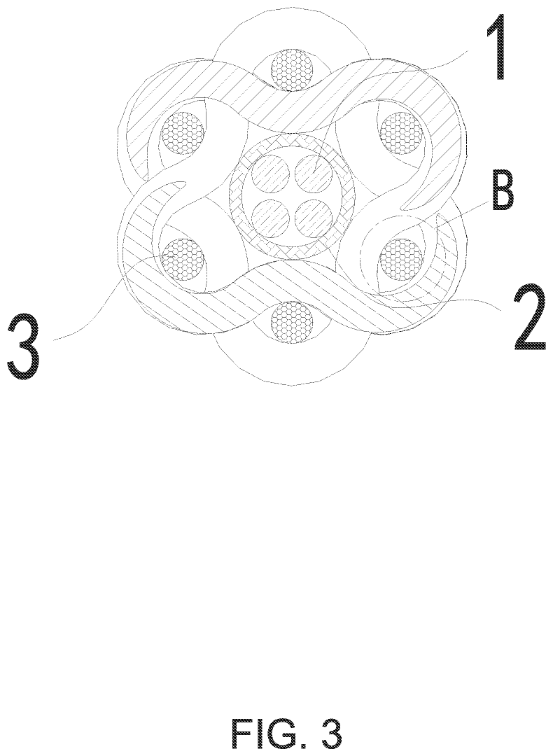

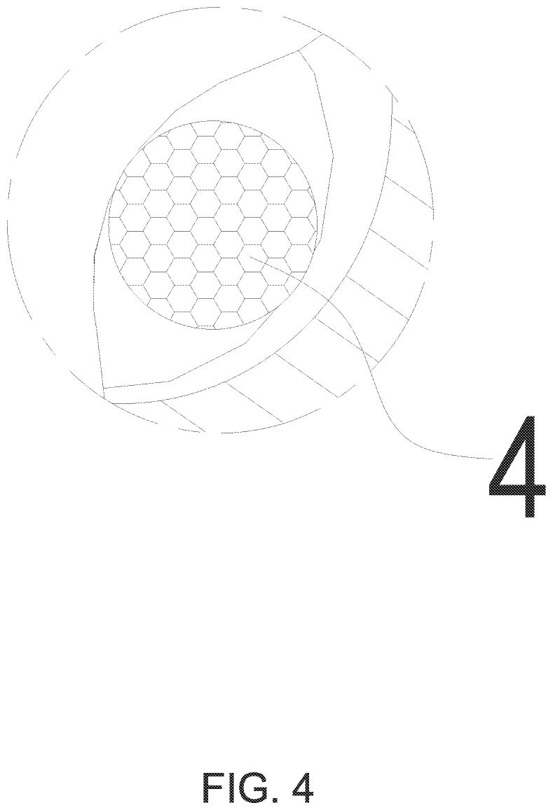

Please refer to FIGS. 1, 2, and 3. A data cable with an anti-stretching and bite-resistant woven layer includes an inner core line 1, the inner core line 1 includes several sub lines, and the sub lines include two power lines and two signal lines; an isolation layer 2 wrapping the inner core wire, serving as an isolation protection and configured to protect the inner core wire whiling isolating; a metal woven protective layer 3 that is composed of multiple strands of metallic thread woven by overlapping in a transverse direction and diagonal direction to form a dense network structure, rendering the date cable with the metal protective layer 3 has bite-resistant and anti-breaking properties, and it has a function of effectively preventing data loss caused by damaging the inner core cable by pets when biting it. Please refer to FIG. 4. The metallic thread is made of a metal wire having high tensile strength or mixed with nylon wire or carbon fiber wire to weave into strands, allowing the data cable have flexibility, being capable of bending at a certain degree of curvature and avoiding knots; a surface of the metal wire has an insulation layer, which provides an insulation protection for the surface of the metal woven layer; avoids a risk of fire caused by a short circuit as a contact of a metal outer wall with a charged device.

The above embodiments are only used to illustrate the technical solution of the present disclosure, not to limit it. Under a concept of the present disclosure, the technical features in the above embodiments or different embodiments can also be combined, and the steps can be implemented in any order. There are many other changes in different aspects of the present disclosure as described above, which are not provided in detail for simplicity. Although the present disclosure has been described in detail with reference to the above embodiments, ordinary technical personnel in the art should understand that they can still modify the technical solutions recorded in the above embodiments or equivalently substitute some of the technical features; and these modifications or substitutions do not separate the essence of the corresponding technical solutions from the scope of the technical solutions of the various embodiments of the present disclosure.

What is claimed is:

1. A data cable with an anti-stretching and bite-resistant woven layer, comprising an inner core wire; an isolation layer wrapping the inner core wire and serving as isolation protection; a single stranded metallic thread that is woven into an anti-stretching and bite-resistant metal protective layer by crossing and overlapping.

2. The data cable with an anti-stretching and bite-resistant woven layer according to claim 1, wherein, the metal protective layer is composed of multiple strands of metallic thread that are woven by overlapping in a transverse direction and diagonal direction to form a dense network structure.

3. The data cable anti-stretching and bite-resistant woven layer according to claim 2, wherein, the metallic thread is made of a metal wire having high tensile strength or mixed with nylon wire and carbon fiber wire to weave into strands.

4. The data cable anti-stretching and bite-resistant woven layer according to claim 3, wherein, a surface of the metal wire has an insulation layer.
